(19) United States
(12) Patent Application Publication
(10) Pub. No.: US 2004/0116646 A1
(43) Pub. Date: Jun. 17, 2004

(54) Molded material comprising thermoplastic polyurethane consisting of ether-containing polyester polyol and method thereof, and product therethrough

(76) Inventors: Jin-suk Choi, Kyunggi (KR); Young-whi Park, Pusan metropolitan city (KR); Yang-lae Cho, Kyungsangnam-do (KR); Seoung-lyong Song, Pusan metropolitan city (KR); Dae-young Kwon, Kyungsangbook-do (KR); Hyoung-jae Kim, Kyunggi-do (KR); Sung-ho Kim, Kyunggi-do (KR); Dea-up Kim, Kyunggi-do (KR)

Correspondence Address: GREENBLUM & BERNSTEIN, P.L.C., 1950 ROLAND CLARKE PLACE, RESTON, VA, 20191, US

(21) Appl. No.: 10/467,056

(22) PCT Filed: Nov. 30, 2001
(86) PCT No.: PCT/KR01/02074

(30) Foreign Application Priority Data
Oct. 10, 2001 (KR) 2001/62458

(51) Int. Cl. B29C 47/00; C08G 18/00; C08G 18/10; C08G 18/32

(52) U.S. Cl. 528/66; 264/28; 264/140; 264/176.1

(57) ABSTRACT

Disclosed is a thermoplastic polyurethane for slash molding, excellent in moldability, capable of providing a skin material having a uniform thickness, and capable of allowing a minute laser processing or the like to be vehicleried out thereon. Also, the present invention discloses a skin material comprising the thermoplastic polyurethane. The thermoplastic polyurethane of the present invention is prepared in a form of a powdery resin by mixing and then condensing an amount of 15-60 parts by weight of one or more isocyanate compounds; an amount of 30-70 parts by weight of an ether-containing polyester polyol; and an amount of 5-40 parts by weight of one or more chain extenders.

### TECHNICAL FIELD

The present invention, in general, relates to a molded material comprising thermoplastic polyurethane consisting of an ether-containing polyester polyol. More particularly, the present invention relates to a molded material having improved product qualities such as design flexibility, embossing quality and tactile sensation; durability such as scratch resistance, heat-aging resistance, photo resistance and chemical resistance; and safety features such as anti-fogging property, flame retardance and allowance of smooth inflation of air bag, which is obtained by using thermoplastic polyurethane consisting of an ether-containing polyester polyol as a skin material for instrument panels of vehicles.

### PRIOR ART

Typically, skin materials for instrument panels of vehicles require excellent product qualities of design flexibility, embossing quality, tactile sensation, etc.; excellent durability in scratch resistance, heat aging resistance, photo resistance, chemical resistance, etc.; and excellent safety features in anti-fogging property, flame retardance, allowance of smooth inflation of air bag, etc. In this regard, polyvinyl chloride (PVC) having excellent properties satisfying such requirements is widely used through vacuum forming, powder slush molding (PSM), and the like.

The instrument panels are largely classified into a pad type to which polyurethane serving as a pad material is attached, and a non-pad type formed by injection molding.

The pad type is composed of a core material, a pad material and a skin material. The core material, which is made of materials having excellent mechanical and physical properties, such as polypropylene filler (PPF) or PC/ABS, functions as a core part in a molded material and to provide mechanical strength to the molded material. In addition, the pad material is mainly a shock-absorbing agent, like polyurethane foam, and functions to absorb external impact, while being wrapped in the skin material to provide soft texture. The skin material, as described above, which forms the external surface of the molded material, is a part to directly contact the skin of users, and offers improved aesthetic effect and tactile sensation according to designs.

Pad-type skin materials are generally prepared by the vacuum forming method or powder slush molding (PSM) method. Vacuum forming of the skin materials is achieved by heating a pre-extruded resin in a sheet form under vacuum, pouring the heated resin into a mold, cooling the resulting resin, and then removing the molded resin from the mold. On the other hand, the PSM method comprises shaking and rotating together a mold heated at high temperature and a vessel containing resin powder to melt the resin powder in a mold, and cooling the mold to solidify the melted resin. Compared to the vacuum forming, the PSM method is advantageous in terms of fully representing design and embossing features. For this reason, the PSM method is mainly used in preparing the instrument panels of deluxe vehicles.

In a study analyzing 77 types of skin materials used in instrument panels of vehicles in North America in 2001, it was found that polyvinyl chloride (PVC) molded by the PSM method and vacuum molding method is most often utilized.

However, PVC prepared by the PSM and vacuum molding methods has weak heat resistance and is hard to apply to air-bags intended to be contained as an internal part in vehicles, as well as generating dioxin upon burning and thus being limitated in its use. Therefore, there is an urgent need for development of molded materials such as instrument panels comprising new skin materials capable of being recycled as well as having improved tactile qualities and heat resistance.

### DISCLOSURE OF THE INVENTION

Therefore, it is an object of the present invention to provide a molded material having improved product qualities such as design flexibility, embossing quality and tactile sensation; durability such as scratch resistance, heat aging resistance, photo resistance and chemical resistance; and safety such as anti-fogging property, flame retardance and allowance of smooth inflation of air bag, which is obtained by using thermoplastic polyurethane consisting of an ether-containing polyester polyol as a skin material for instrument panels of vehicles.

### BEST MODES FOR VEHICLERYING OUT THE INVENTION

In accordance with the present invention, there is provided a molded material, comprising thermoplastic polyurethane consisting of an ether-containing polyester polyol, and consisting of a core material, a pad material and a skin material. The skin material is prepared by mixing an amount of 15-60 parts by weight of one or more isocyanate compounds selected from the group consisting of diphenyl methane diisocyanate (MDI), toluene diisocyanate (TDI), hexamethylene diisocyanate (HDI) and dicyclohexylmethane diisocyanate (H12MDI); an amount of 30-70 parts by weight of an ether-containing polyester polyol; and an amount of 5-40 parts by weight of one or more chain extenders selected from the group consisting of diols, which are exemplified as ethylene glycol, diethylene glycol, butane diol or hexane diol, triols such as trimethylol propane, and polytetramethylene ether glycol, and then condensing the resulting mixture.

The ether-containing polyester polyol is prepared by mixing an amount of 40-80 parts by weight of one or more multifunctional vehicleboxylic acids selected from the group consisting of adipic acid, sbelic acid, abelic acid, azelic acid, sebacic acid, dodecandioic acid and trimeric acid; and an amount of 20-100 parts by weight of polytetramethylene ether glycol (PTMG) containing one or more multifunctional alcohol compounds having a hydroxyl value of from 561.0 to 56.1 mgKOH/g, selected from the group consisting of diols, which are exemplified as ethylene glycol, butane diol or hexane diol, and triols such as trimethylol propane, and then reacting the resulting mixture, thereby giving a hydroxyl value of from 224.11 to 11.22 mgKOH/g.

### EXAMPLE

In accordance with the present invention, a molded material, comprising thermoplastic polyurethane consisting of an ether-containing polyester polyol, consists of a core material, a pad material and a skin material. The skin material is prepared by mixing an amount of 15-60 parts by weight of one or more isocyanate compounds selected from the group consisting of diphenyl methane diisocyanate (MDI), toluene diisocyanate (TDI), hexamethylene diisocyanate (HDI) and dicyclohexylmethane diisocyanate (H12MDI); an amount of 30-70 parts by weight of an ether-containing polyester polyol; and an amount of 5-40 parts by weight of one or more chain extenders selected from the group consisting of diols, which are exemplified as ethylene glycol, diethylene glycol, butane diol or hexane diol, triols such as trimethylol propane, and polytetramethylene ether glycol, and then condensing the resulting mixture.

The thermoplastic polyurethane comprises an ether-containing polyester polyol prepared by mixing an amount of 40-80 parts by weight of one or more multifunctional vehicleboxylic acids selected from the group consisting of adipic acid, sbelic acid, abelic acid, azelic acid, sebacic acid, dodecandioic acid and trimeric acid; and an amount of 20-100 parts by weight of polytetramethylene ether glycol (PTMG) containing one or more multifunctional alcohol compounds having a hydroxyl value of from 561.0 to 56.1 mgKOH/g, selected from the group consisting of diols, which are exemplified as ethylene glycol, butane diol or hexane diol, and triols such as trimethylol propane, and then reacting the resulting mixture, thereby giving a hydroxyl value of from 224.11 to 11.22 mgKOH/g.

The isocyanate compound useful in the present invention may include isocyanate compounds commonly used in preparing polyurethane, wherein the conventional isocyanate compounds may be used in the same or similar manner as or to the conventional usage manner, and are preferably selected from the group consisting of aromatic isocyanate, aliphatic isocyanate or alicyclic isocyanate, and more preferably, one or more selected from the group consisting of diphenyl methane diisocyanate (MDI), toluene diisocyanate (TDI), hexamethylene diisocyanate (HDI) and dicyclohexylmethane diisocyanate (H12MDI).

The ether-containing polyester polyol is prepared by mixing an amount of 40-80 parts by weight of one or more multifunctional vehicleboxylic acids selected from the group consisting of adipic acid, sbelic acid, abelic acid, azelic acid, sebacic acid, dodecandioic acid and trimeric acid; and an amount of 20-100 parts by weight of polytetramethylene ether glycol (PTMG) containing one or more multifunctional alcohol compounds having a hydroxyl value of from 561.0 to 56.1 mgKOH/g, selected from the group consisting of diols, which are exemplified as ethylene glycol, butane diol or hexane diol, and triols such as trimethylol propane, and then reacting the resulting mixture, thereby giving a hydroxyl value of from 224.11 to 11.22 mgKOH/g.

In an embodiment of the present invention, the ether-containing polyester polyol may be prepared by mixing the multifunctional vehicleboxylic acid, the multifunctional alcohol compound and the polytetramethylene ether glycol, heating the mixture from room temperature to 140-160° C. and then maintaining the heated mixture at 150° C. for about 60-120 min, increasing the temperature of 150° C. to 210-230° C. and then maintaining the mixture at 220° C. for about 10-120 min, reacting the resulting mixture under vacuum of 650-760 mmHg at 220° C., and then stopping the reaction when a hydroxyl value is below 1 mgKOH/g, thereby giving a hydroxyl value of 224.11 to 11.22 mgKOH/g.

The chain extender may be selected from the group consisting of diols, which are exemplified as ethylene glycol, diethylene glycol, butane diol or hexane diol, triols such as trimethyol propane, polytetramethylene ether glycol (PTMG), and mixtures thereof.

The thermoplastic polyurethane comprising an ether-containing polyester polyol may be prepared by primarily mixing an amount of 30-70 parts by weight of an ether-containing polyester polyol and an amount of 5-40 parts by weight of a chain extender at 30-100° C. for 1-10 min with stirring; adding an amount of 15-60 parts by weight of isocyanate to the first mixture and secondarily mixing the resulting mixture with stirring at 300-1,000 rpm for 1-10 min; ripening the second mixture at 60-140° C. for 1-48 hrs; pulverizing the resultant obtained from the ripening step at a temperature below 0° C.; and extruding the pulverized mixture at a temperature ranging from 150 to 300° C.

At the first mixing step, the polyol compound and the chain extender are primarily homogeneously mixed, while at the second mixing step, the isocyanate compound and the ether-containing polyester polyol are mixed to produce polyurethane.

In the embodiment of the present invention, it was found that the isocyanate compound and the ether-containing polyester polyol react rapidly after mixing. In particular, the molecular weight of the polyurethane may be controlled through the ripening step of the polyurethane obtained from the second mixing step. The pulverizing and extruding steps allow the polyurethane to have a suitable size. Through the pulverizing and extruding steps, the polyurethane is formulated into pellets capable of being processed into goods.

The present invention will be explained in more detail with reference to the following examples. However, the following examples are provided only to illustrate the present invention, and the present invention is not limited to them.

### EXAMPLE 1

After mixing 49.6 kg of adipic acid, 22.0 kg of 1,4-butylene glycol, and 40.7 kg of polytetramethylene ether glycol having a hydroxyl value of 448.8 mgKOH/g, the mixture was heated from room temperature to 150° C., maintained at 150° C. for about 90 min, then further heated to 220° C., and maintained at 220° C. for about 30 min. Then, the heated mixture was reacted under vacuum of 720 mmHg, and the reaction was terminated when a hydroxyl value of the mixture reached below 1 mgKOH/g, resulting in production of an ether-containing polyester polyol having a condensation number of 12.29 and a hydroxyl value of 74.8 mgKOH/g. Thereafter, 61 kg of the ether-containing polyester polyol was mixed with 6 kg of 1,4-butylene glycol at 60° C. for 3 min with stirring. After 43 kg of hexamethylene diisocyanate was added to the mixture, the resulting mixture was mixed with stirring at 500 rpm for 3 min, thus generating a condensed mixture. Then, the condensed mixture was ripened at 80° C. for 8 hrs. Continuously, the ripened condensed mixture was pulverized at a temperature below 0° C. to form a flake, and the pulverized flack was extruded at 180° C. to formulate it into pellets. Using the thermoplastic polyurethane in pellet form, a molded product consisting of a core material, a pad material and a skin material was prepared according to the PSM method known in the art, and a part of the molded material was used as a test material in Experimental Examples, below.

### Comparative Examples 1-4

In Comparative Examples 1 to 4, a part of commercially available instrument panels was used as a test material.

In Comparative Example 1, a part of a molded product prepared according to the known PSM method using polyvinyl chloride of Hanwha Living & Creative Corp., Korea as a skin material was used as a test material. In Comparative Example 2, a part of a molded product prepared according to the known vacuum forming method using a polyvinyl chloride/ABS resin (acrylonitrile-butadiene-stylene copolymer) of LG Chem. Ltd., Korea as a skin material was used as a test material. In Comparative Example 3, a part of a molded product prepared according to the known vacuum forming method using thermoplastic polyolefin of LG Chem. Ltd., Korea as a skin material was used as a test material. In Comparative Example 4, a part of a molded product comprising polyester of Bayer Company, USA as a skin material was used as a test material.

### Experimental Example 1

### Determination of Specific Gravity

In this test, specific gravity of each sample was evaluated by the underwater substitution method defined in ASTM D 792. The results are given in Table 1, below.

### Experimental Example 2:

### Determination of Tensile Strength

Tensile strength of each sample was measured by the method defined in clause 3 of JIS K 6301 using a 1-ton universal test machine of the MTS Company, USA. The results are given Table 1, below, in which the tensile specimen was a type-1 dumbell, and tension speed was 200 mm/min.

### Experimental Example 3:

### Evaluation of Skin Hardness

Skin hardness was evaluated according to the method defined in ASTM D 2240 using a type-A Shore hardness tester at an initial compression state. The results are given in Table 1, below.

### Experimental Example 4:

### Evaluation of Scratch Resistance

Scratch resistance was evaluated by investigating skin appearance when scratching once a test piece prepared according to the method in SUS 403 by placing a weight of 300 g on the piece. Evaluation of skin appearance was divided into five grades according to extent to scratches formed on the skin, ranging from 1 grade where skin is remarkably damaged to 5 grade where no damage of skin is recognized. The results are given in Table 1, below.

### Experimental Example 5:

### Impact Test

A high-speed impact test for skin materials was performed in an alcohol bath at −30° C. using the drop weight impact tester Dynatup (General research Inc. Ltd. C02D, USA). Skin materials to which polyurethane pads werre attached (Example 1 and Comparative Example 3) were evaluated at room temperature. The results are given in Table 1, below, in which cross head weight of the tester was 11:83 kg, impact speed and impact energy was 6 m/sec and 102 J, respectively, and diameter of an impact bar was 13 mm.

### Experimental Example 6:

### Evaluation of Heat-aging Resistance

Heat-aging resistance was evaluated by performing aging using a constant temperature & humidity chamber at 120° C. for 500 hrs, and then measuring color difference using a calorimeter. The results are given in Table 1, below.

### Experimental Example 7:

### Evaluation of Photo Resistance

Photo resistance was evaluated by investigating changes in color of samples using the accelerated photo resistance testing machine, Atlas Ci 65 Xenon Arc Weather-O-meter, under the conditions of a phase wavelength of 340 mm, a light intensity of 53 W/m² and temperature of 89° C., for 500 hrs. The results are given in Table 1, below.

TABLE 1

| | E. 1 | C. E. 1 | C. E. 2 | C. E. 3 | C. E. 4 |
|---|---|---|---|---|---|
| Specific gravity | 1.13 | 1.20 | 1.28 | 0.92 | 1.08 |
| Tensile strength (kgf/km) | 66 | 122 | 148 | 100 | 70 |
| Skin hardness (Shore A) | 64 | 78 | 94 | 76 | 78 |
| Scratch resistance | 4 | 5 | 5 | 5 | 5 |
| Impact property | | | | | |
| Skin material | 6.2 | 12.0 | 12.1 | 7.8 | 12.8 |
| Skin material⁺ | 6.8 | — | — | 8.0 | — |
| Heat aging resistance | | | | | |
| Skin material | 1.5 | 0.4 | 0.4 | 1.2 | 2.8 |
| Skin material⁺ | 1.5 | 1.0 | 1.3 | 1.1 | 3.1 |
| Photo resistance | | | | | |
| Skin material | 1.1 | 1.2 | 0.4 | 0.4 | 0.2 |
| Skin material⁺ | 0.7 | 0.8 | 0.9 | 0.7 | 0.7 |

As shown in Table 1, above, the molded material prepared in Comparative Example 2 has the lowest specific gravity owing to physical properties of the skin material contained therein. Because of having lower specific gravity than the molded materials prepared in Comparative Examples 1 and 2, which employed the conventionally used slain material, the molded material prepared in Example 1 according to the method of the present invention was about 6-10% higher. In addition, the molded material of Example 1 has similar specific gravity to that of Comparative Example 4, indicating that it can be applied to vehicles. Through the weight-reducing effect, the skin materials of the present invention can provide improved acceleration property, handling and fuel efficiency of motor vehicles.

In terms of tensile strength, it was found that the molded materials prepared in Comparative Examples 1 and 2 had relatively high tensile strength at the break point, whereas the molded material prepared in Example 1 according to the present invention has a very low tensile strength. Thermoplastic polyurethane is not required to have high tensile strength when preparing a molded material by the PSM method, not the vacuum forming method. Low tensile strength is advantageous in terms of ensuring bursting strength at a laser scoring line upon air-bag deployment in a low level and thus ensuring high air-bag deployment property.

In terms of the skin hardness, it was found that the molded material prepared in Comparative Example 2 has the highest skin hardness, and the molded materials prepared in Comparative Examples 1, 3 and 4 have skin hardnesses similar to each other, while the molded material prepared in Example 1 has the lowest skin hardness, indicating that the molded material prepared according to the present invention has excellent tactile properties.

Typically, low skin hardness accompanies low scratch resistance. In terms of scratch resistance, the molded material prepared in Example 1 according to the present invention was evaluated as grade 4 in which slight skin damage is observed, thereby satisfying Korean domestic standards. This result indicates that such slight skin damage can be controlled according to embossing patterns.

In terms of impact property, the molded materials prepared in Comparative Examples 1 and 2 were found to have weak cold behavior, thus undergoing brittle breakage upon performing the high-speed impact test. This property of the molded materials of the Comparative Examples 1 and 2 may mean that when being deployed according to a laser scoring line, an air-bag may be deployed in a manner of being deviated from the laser scoring line, that severe cracks are formed on the surface of the skin material by indirect impact, or that passengers are damaged by broken pieces of the molded material. In contrast, the skin materials prepared in Example 1 according to the present invention and Comparative Example 3 were found to have sufficiently low glass transition temperature (Tg), thereby not causing such problems as in the skin materials of Comparative Examples 1 and 2.

Typically, instrument panels of vehicles are exposed to a relatively higher amount of sunlight than other parts, resulting in sharp increases of temperature inside the vehicle. Such sharp increase in the internal temperature of vehicles may cause the structure of high molecular weight molecules to change, and thus cause their degradation. In this regard, heat resistance of the instrument panel is one of the most important durability factors determining quality of vehicles.

The general standard for color difference, approved in the vehicle industry, is that the ΔE value is below 3. All skin materials prepared in Example 1 and Comparative Examples 1 to 4 were found to satisfy the ΔE value below 3.

Especially in Comparative Example 4, the skin material was found to barely satisfy the standard ΔE value. In the case that a polyurethane pad is attached to a skin material, color of the skin material is changed, which differs from that of a skin material not containing a polyurethane pad. When using polyvinyl chloride as a skin material, polyvinyl chloride reacts with amine groups migrated from a polyurethane pad under high temperature, causing rapidly increased yellowing phenomenon. In contrast, in case of the skin materials prepared in Comparative Example 3 and Example 1 according to the present invention, very little change in color was found, indicating that yellowing by migration of amine groups rarely occurs.

In case of photo resistance, similar patterns to the above results were found in the skin materials prepared in Example 1 and Comparative Examples.

As described above, in terms of weight reduction, tactile, air-bag allowance of smooth inflation of air bag and potential to be recycled, the molded material comprising thermoplastic polyurethane consisting of an ether-containing polyester polyol according to present invention was demonstrated to be optimal for instrument panels.

### Industrial Applicability

As described hereinbefore, the skin material according to the present invention is effective in generating a molded material having improved product qualities such as design flexibility, embossing quality and tactile sensation; durability such as scratch resistance, heat aging resistance, photo resistance and chemical resistance; and safety features such as anti-fogging property, flame retardance and allowance of smooth inflation of air bag.

The present invention has been described in an illustrative manner. Many modifications and variations of the present invention are possible in light of the above teachings. Therefore, it is to be understood that within the scope of the appended claims, the invention may be practiced otherwise than as specifically described.

1. A thermoplastic polyurethane comprising an ether-containing polyester polyol, which is prepared by mixing and then condensing an amount of 15-60 parts by weight of one or more isocyanate compounds selected from the group consisting of diphenyl methane diisocyanate (MDI), toluene diisocyanate (TDI), hexamethylene diisocyanate (HDI) and dicyclohexylmethane diisocyanate (H12MDI); an amount of 30-70 parts by weight of an ether-containing polyester polyol; and an amount of 5-40 parts by weight of one or more chain extenders selected from the group consisting of diols, which are exemplified as ethylene glycol, diethylene glycol, butane diol or hexane diol, triols such as trimethylol propane, and polytetramethylene ether glycol, and then condensing the resulting mixture,
wherein, the ether-containing polyester polyol is prepared by mixing an amount of 40-80 parts by weight of one or more multifunctional vehicleboxylic acids selected from the group consisting of adipic acid, sbelic acid, abelic acid, azelic acid, sebacic acid, dodecandioic acid and trimeric acid; and an amount of 20-100 parts by weight of polytetramethylene ether glycol containing one or more multifunctional alcohol compounds having a hydroxyl value of from 561.0 to 56.1 mgKOH/g, selected from the group consisting of diols, which are exemplified as ethylene glycol, butane diol or hexane diol, and triols such as trimethylol propane, and then reacting the resulting mixture, thereby giving a hydroxyl value of from 224.11 to 11.22 mgKOHg.

2. A method of preparing thermoplastic polyurethane comprising an ether-containing polyester polyol, comprising the steps of:
primarily mixing an amount of 30-70 parts by weight of the ether-containing polyester polyol of claim 1 and an amount of 5-40 parts by weight of a chain extender at 30-100° C. for 1-10 min with stirring to prepare a first mixture;
adding an amount of 15-60 parts by weight of isocyanate to the first mixture and secondarily mixing the resulting mixture with stirring at 300-1,000 rpm for 1-10 min to prepare a second mixture;
ripening the second mixture at 60-140° C. for 1-48 hrs;
pulverizing the resultant obtained from the ripening step at temperature below 0° C.; and
extruding the pulverized mixture at a temperature ranging from 150 to 300° C.

3. A molded material comprising the ether-containing polyester polyol of claim 1 or 2 having a hydroxyl value of 221.11 to 11.22 mgKOH/g.

4. The molded material as set forth in claim 3, wherein the molded material is used as a skin material for interior parts of a vehicle.

5. The molded material as set forth in any one of claims 1, 2 and 4, wherein the molded material is in a form of particles modified by pulverization and extrusion, or in a pellet form.
